(19) United States
(12) Patent Application Publication
(10) Pub. No.: US 2026/0093029 A1
(43) Pub. Date: Apr. 2, 2026

(54) NETWORKED ECOSYSTEM WITH EXTENDED MULTI-HOP PROXIMITY RANGING

(71) Applicant: GM GLOBAL TECHNOLOGY OPERATIONS LLC, Detroit, MI (US)

(72) Inventors: Venkata Naga Siva Vikas Vemuri, Farmington Hills, MI (US); Azin Neishaboori, Plymouth, MI (US); Jinzhu Chen, Troy, MI (US); Paolo Giusto, Brentwood, CA (US); John Sergakis, Bloomfield Hills, MI (US)

(73) Assignee: GM GLOBAL TECHNOLOGY OPERATIONS LLC, Detroit, MI (US)

(21) Appl. No.: 18/904,310

(22) Filed: Oct. 2, 2024

(51) Int. Cl. G01S 13/76; H04W 4/02; H04W 40/20; H04W 88/04

(52) U.S. Cl. CPC G01S 13/767; H04W 4/023; H04W 40/20; H04W 88/04

(57) ABSTRACT

A proximity ranging method for use in a networked ecosystem having an initiator node, a plurality of relay nodes, and a target node includes accessing a recorded activation profile. The networked ecosystem may include a smart home or another Internet-of-Things (IoT) ecosystem. The activation profile includes a desired action or service of the target node. The method includes using a proximity ranging protocol to estimate a range to one or more neighboring nodes of the plurality of relay nodes within a range limit of the initiator node. The target node is located outside of the range limit of the initiator node. The method also includes dynamically determining an internodal distance between the initiator node and the target node using the one or more neighboring nodes.

### INTRODUCTION

Advancements in global automation technology has led to the adoption of network-based management of a myriad of storage, diagnostic, maintenance, sensors, actuators, control, and other operations. For example, at-home charging operations of modern electric vehicles (EVs) or plug-in hybrid electric vehicles (PHEVs) may be scheduled and managed using “smart garage” network connectivity. Other aspects of smart garage automation include smartphone-based monitoring and opening/closing operation of garage doors, as well as control of climate settings such as temperature, humidity, and air quality. Security systems may be similarly managed from a remote location. Within a representative garage environment, such automation also facilitates inventory, tool, and parts management along with a host of other functions. Similar technologies may be applied to other environments, including but not limited to a user's home or office.

The effective implementation of global automation solutions relies on accurate proximity ranging between connected devices, more generally referred to as communication nodes. Proximity ranging in the context of global smart garage automation and other exemplary Internet of Things (IoT) applications generally refers to the process of determining a distance between such nodes. Common proximity ranging techniques using electromagnetic waves include estimating a distance between a transmitter and a receiver based on received signal strength, based on the amount of time it takes for a transmitted packet from a transmitter to reach the receiver, i.e., time-of-flight, and other techniques. The transmitted signals may be ultra-wideband (UWB), Bluetooth Low Energy (BLE), Wi-Fi, etc. However, such techniques are only capable of measuring a proximity range up to a maximum limit. For some emerging home or industrial IoT use cases demanding low-latency, such maximum limits for range measurements may result in a suboptimal user experience.

### SUMMARY

The present disclosure pertains to a proximity ranging protocol for use in a local networked ecosystem. The solutions presented herein-referred to hereinafter as “multi-hop” proximity ranging—are intended to address potentially problematic issues such as ranging latency, ranging limit, out-of-range (OOR) service activation, network overload, and suboptimal customer experience in an Internet of Things (IoT) environment, e.g., the above-noted global smart garage application. The proposed proximity ranging protocol may be used to govern end-to-end proximity ranging in the above-noted local networked ecosystem, within which an initiator node requests multiple connected relay nodes to estimate the distance to an out-of-range target node. The disclosed protocol may be implemented to dynamically estimate the distance between the initiator node and target node using either a decentralized model or a centralized model, both of which are described in detail below. The decentralized model relies on peer-to-peer relay nodes to reach the target node when activating services hosted on or involving operation of the target node. The alternative centralized model for its part envisions a central controller operable to reach the target node for the above-noted service activation.

In particular, a proximity ranging method is disclosed herein for use in a networked ecosystem having an initiator node, a plurality of connected nodes (“relay nodes”), and a target node. The method in accordance with a representative embodiment includes accessing a recorded activation profile, the activation profile including a desired action or service of the target node. The method also includes using a proximity ranging protocol to estimate a range to one or more neighboring nodes of the plurality of relay nodes within a proximity range limit of the initiator node. The target node is located outside of the range limit of the initiator node, and thus located too far away for a direct exchange of wireless signals. Additionally, the method in this embodiment includes dynamically determining an internodal distance between the initiator node and the target node using the one or more neighboring nodes, and thereafter triggering the desired action or service upon determining that the internodal distance is not greater than an activation threshold.

In a possible embodiment, one or more neighboring nodes are within a range limit of the target node.

Determining the internodal distance between the initiator node and the target node may be based on estimating an angle-of-arrival of a signal exchanged between the initiator node and a neighboring node. The method may include estimating an angle-of-arrival of a signal exchanged between the target node and the neighboring node. Estimating the respective range to a neighboring node may be further based on the time-of-arrival of a signal sent by the initiator node to the neighboring node.

Upon estimating the proximity range to a neighboring node, the method may include instructing the neighboring node to estimate the range between itself and the target node. This action may include sending a signal to the neighboring node.

In one or more embodiments, dynamically determining an internodal distance between the initiator and target nodes may include recursively determining an internodal distance between a first node and a second node using an intermediate node, with the first, second, and intermediate node being one of the aforementioned initiator, relay, and target nodes. The second node in this implementation is outside the range limit of the first node. The intermediate node is in a proximity range limit of both the first and second nodes. The first node, the second node, and the intermediate node are nodes on a determined ranging route between the initiator node and the target node.

In response to failing to estimate the respective range to one of the neighboring nodes, as an undetected node, reattempting to estimate the respective range to the undetected node, or selecting an alternative nodal route from the initiator node to the target node.

Accessing the recorded activation profile in the computer storage medium may include accessing the recorded activation profile in memory of a central controller, the central controller being in remote communication, via a Wi-Fi router, with: (a) the initiator node and one or more of the relay nodes, and (b) one or more of the relay nodes and the target node via the Wi-Fi router and a border router. Estimating the respective ranges to the one or more neighboring nodes in a possible embodiment includes measuring a time-of-arrival (ToA) and an angle-of-arrival (AoA) of a signal sent by the initiator node to the one or more neighboring nodes.

As part of the method, measuring the time-of-arrival (ToA) and the angle-of-arrival (AoA) of a signal may be performed using an ultra-wideband (UWB)-capable node.

A shortest distance algorithm may be used to determine a nodal path from the initiator node to the target node through the one or more neighboring nodes.

The method in accordance with an embodiment includes generating a data package via the initiator node, as well as transmitting the data package to the one or more neighboring nodes. The data package includes a unique identifier of the initiator node, the ToA, the AoA, and a unique identifier of the one or more neighboring nodes. In response to the data package being received from the initiator node, the method may include sending a response data package via each of the one or more neighboring nodes, including sending the unique identifier of each of the one or more neighboring nodes, an angle-of-arrival of reception of the data package, and the time-of-arrival of the data package.

Embodiments of the method include periodically checking a status and connectivity of the one or more neighboring nodes at a sampling frequency, and then adjusting the sampling frequency based on a characteristic of the one or more neighboring nodes. The method may further includes rank-ordering the one or more neighboring nodes in a table based on predetermined criteria, and also dynamically updating the table to thereby prioritize the one or more neighboring nodes for the action or service.

The initiator node may include a smartphone or a vehicle and the target node includes a smart home device, accessing the recorded activation profile may include accessing a recorded light, door, appliance, and/or vehicle charging station setting of the smart home device.

Another aspect of the disclosure includes a networked ecosystem, an embodiment of which an initiator node, a plurality of relay nodes including at least one transit node and at least one smart node, a target node that is located outside of the range limit of the initiator node, and computer storage medium (memory) containing a recorded activation profile. The recorded activation profile includes a desired action or service of the target node.

The networked ecosystem in this embodiment is configured to use a proximity ranging protocol to detect respective ranges to one or more neighboring nodes of the plurality of relay nodes within a range limit of the initiator node, to dynamically determine an internodal distance between the initiator node and the target node based at least in part on the respective ranges to the one or more neighboring nodes, and triggering the desired action upon determining that the internodal distance between the initiator and the target node is not greater than an activation threshold.

In another embodiment, the networked ecosystem includes an initiator node in the form of a smartphone or a vehicle having ultra-wideband (UWB) capability. The networked ecosystem also includes a plurality of relay nodes, including at least one transit node and at least one UWB-capable smart node. A target node is located outside of the range limit of the initiator node, and is configured as a smart home device. A computer storage medium (memory) contains an activation profile, the activation profile including a desired action or service of the target node, the desired action or service including a light, door, appliance, and/or vehicle setting of the smart home device.

Also included in this embodiment is a Wi-Fi router, a border router, and a central controller. The controller is in communication with the initiator node and one or more of the relay nodes via the Wi-Fi router, and with the one or more of the relay nodes and the target node via the Wi-Fi router and the border router. The networked ecosystem is configured to use a proximity ranging protocol to detect respective ranges to one or more neighboring nodes of the plurality of relay nodes within a range limit of the initiator node, dynamically determine an internodal distance between the initiator node and the target node using the respective ranges to the one or more neighboring nodes, rank-order the one or more neighboring nodes in a table based on predetermined criteria, and dynamically update the table to thereby prioritize the one or more neighboring nodes for the action or service.

The above-summarized features and other features and advantages of this disclosure will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is an illustration of a representative ecosystem configured to use an extended multi-hop proximity ranging and localization strategy set forth herein.

FIG. 2 is a block diagram illustrating a protocol for implementing the extended multi-hop ranging and localization strategy of the present disclosure.

FIGS. 3A and 3B illustrate respective decentralized and centralized models for performing the extended multi-hop proximity ranging and localization strategy in accordance with aspects of the disclosure.

FIG. 4 illustrates an approach for estimating location of the target node based on ranging geometry.

FIG. 5 is a flow chart describing a method for implementing multi-hop proximity ranging and localization in accordance with an aspect of the disclosure.

FIGS. 6 and 7 are block diagrams respectively describing proximity node estimation and dynamic neighbor ranking, both of which are usable as part of the disclosed extended multi-hop proximity ranging and localization strategy.

FIG. 8 is a flow chart describing an implementation of dynamic proximity node estimation in accordance with an embodiment.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

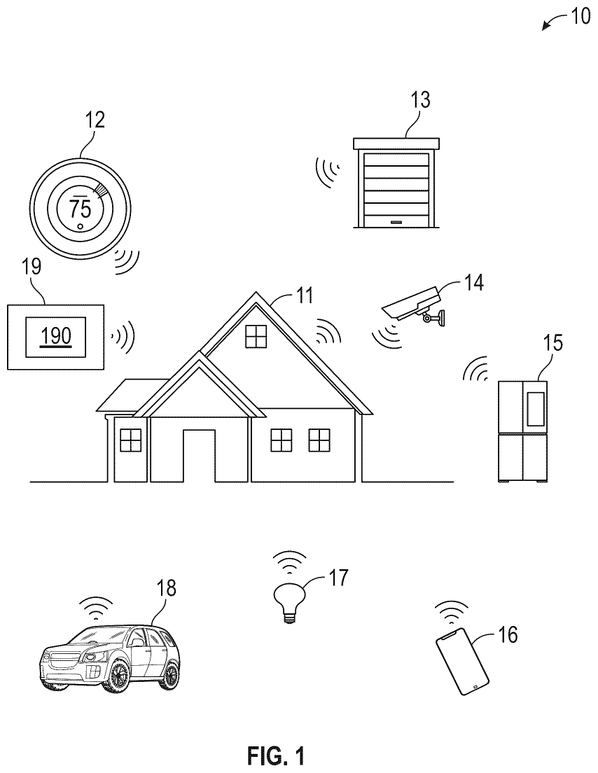

Referring now to the drawings, wherein like reference numbers refer to like features throughout the several views, a local internet-of-things (IoT) networked ecosystem 10 is illustrated in FIG. 1 in which multiple communication nodes are in networked communication with one another. The networked ecosystem 10 is shown and described as a non-limiting global automated smart garage of a smart home 11. In such an embodiment, the above-noted nodes may include one or more of, e.g., a wireless/Wi-Fi-enabled thermostat 12, a garage door 13, a security camera 14, an appliance 15, a smartphone 16 or other smart device, e.g., a smart watch or another wearable, etc., a light bulb 17, a vehicle 18, etc. As will be described below, the networked ecosystem 10 also includes a computer storage medium 19 having an activation profile 190 recorded or stored therein. The actual host or location of the computer storage medium 19 may vary depending on the embodiment, and thus is depicted as separate from the various networked devices in FIG. 1.

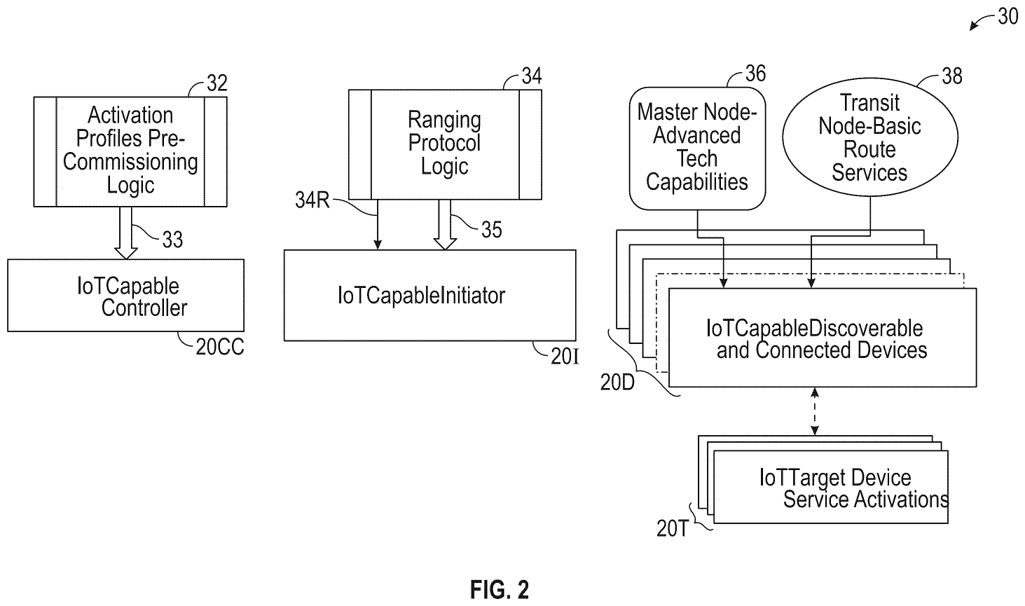

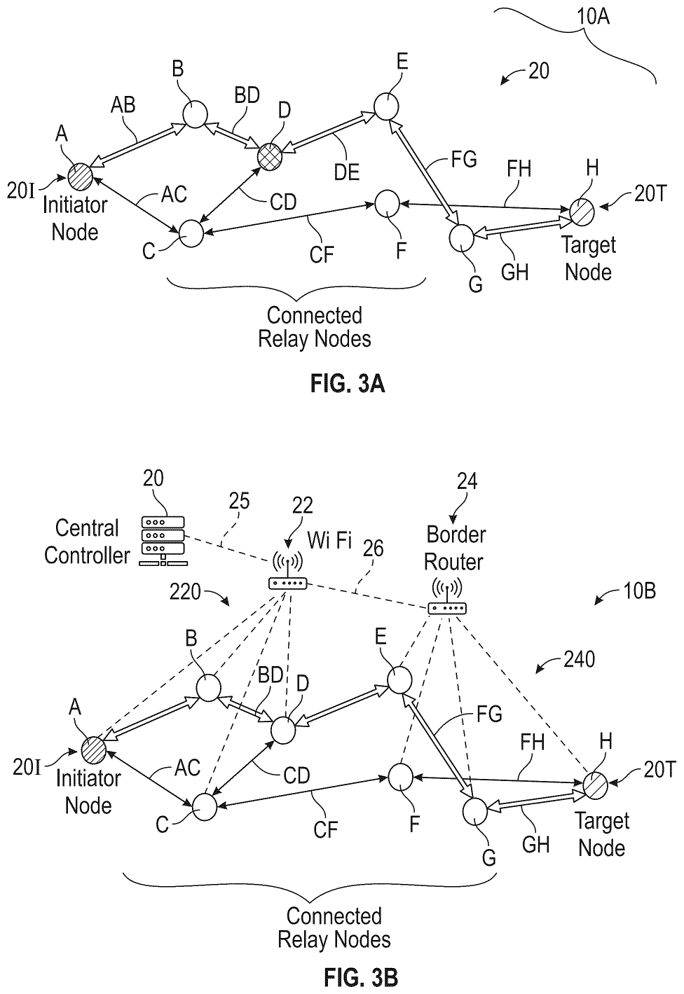

Descriptions of the smart home and representative smart garage implementation of FIG. 1 are used hereinafter solely for illustrative consistency, with the actual number and construction of the constituent nodes participating in the networked ecosystem 10 varying with the intended application. As shown in FIGS. 3A and 3B, the networked ecosystem 10 includes an initiator node 20I and a plurality of connected relay nodes 20R, with the relays nodes 20R including at least one transit node and at least one higher-capability “smart” node as described in detail below. The networked ecosystem 10 also includes a target node 20T that is located outside of the range limit of the initiator node 20I, and the above-noted computer storage medium 19 containing the recorded activation profile 190. The networked ecosystem 10 as set forth herein is configured to use a proximity ranging protocol 30 (FIG. 2) to estimate respective ranges to one or more neighboring nodes of the plurality of relay nodes 20R within a range limit of the initiator node 20I, and to dynamically determine an internodal distance between the initiator node 20I and the target node 20T using the respective ranges.

As contemplated herein, proximity ranging between nodes of the networked ecosystem 10 of FIG. 1 and alternative embodiments thereof involves the accurate estimation of inter-nodal distances. For example, a transmitting node such as the smartphone 16 or vehicle 18 may be used to activate services hosted or provided by one or more receiving nodes, for instance an opener for the garage door 13 or a setting of the thermostat 12 or the security camera 14. In other applications such as manufacturing plant (not shown), an assembly unit controller may be required to locate an automation robot within the plant, e.g., via radio frequency identification (RFID) tags or other device nodes, to request inspection of a potentially faulty part as the part is transported on a conveyor belt. Regardless of the particular construction of the networked ecosystem 10, the networked ecosystem 10 benefits in a variety of ways from the extended multi-hop proximity ranging technique described herein.

As an example, modern proximity ranging techniques for typical smart home/garage and other local network applications are conducted in accordance with the open-source Matter™ standard, which in turn is directed to managing the communication of locally networked devices. In some applications, a device/node may send activation commands to a target node based at least in part on the proximity of the target node. However, users of the networked ecosystem 10 of FIG. 1, or industrial IoT, office, or other use cases, may benefit from reduced latency and the improved customer experience stemming therefrom. For instance, a user walking from a kitchen to a garage of their home may, upon reaching the garage, expect to find the garage door 13 already fully open and their vehicle 18 disconnected from a charging station (not shown), and/or conditioned according to custom settings of the user approaching the vehicle 18 where the conditioning may include one or more of seat adjustments, mirror adjustments, cabin temperature settings, and others. The user's overall experience may be degraded somewhat if the user is left waiting for the scheduled actions to be completed before entering the vehicle 18. The extended multi-hop strategy is therefore directed toward extending communication distances and reducing response latency, preventing out-of-range (OOR) activation errors, and improving the overall customer experience within a local network such as the representative networked ecosystem 10 of FIG. 1.

Although omitted for illustrative simplicity, the hardware associated with the various nodes of FIG. 1 may be in the form of one or more Application Specific Integrated Circuit(s) (ASIC), Field-Programmable Gate Array (FPGA), electronic circuit(s), central processing unit(s), e.g., microprocessor(s) or processors, and associated computer readable storage medium/memory. Non-transitory components of such memory, including the computer storage medium 19 of FIG. 1, are capable of storing machine-readable instructions in the form of one or more software or firmware programs or routines, combinational logic circuit(s), input/output circuit(s) and devices, signal conditioning and buffer circuitry and other components that can be accessed by one or more processors to provide a described functionality. Using such hardware and associated antenna, receivers, and transmitters residing at the various nodes, therefore, information may be exchanged wirelessly between nodes, e.g., via Wi-Fi, Bluetooth™, Bluetooth™ Low-Energy (BLE), etc.

Referring briefly to FIG. 2, an extended multi-hop proximity ranging protocol 30 may be used in the decentralized and centralized alternative embodiments described below with reference to FIGS. 3A and 3B, respectively. The protocol 30 is illustrated as a block diagram for illustrative clarity. In an IoT context, actions are triggered at a target node based on predetermined or prerecorded user profiles. For example, a user of the networked ecosystem 10 of FIG. 1 walking from a kitchen to a garage of the illustrated smart home 11 may, upon reaching the garage, expect the temperature setting, and/or seats and mirrors of vehicle 18 to be adjusted according to their custom levels. Similarly, a user walking around the smart home 11 may set profiles for when to turn on the light bulb 17, charge or stop charging the vehicle 18, etc., relative to the user's position in the smart home 11.

Although such profiles are already set, the extended multi-hop proximity ranging strategy disclosed herein allows extension of the distance between the initiating and target nodes relative to existing strategies, as noted above. This extended range may result in a better user experience, particularly since some actions such as opening/closing doors, disengaging electric vehicle (EV) charging handlers, or custom adjustments within a vehicle in preparation for a specific driver take time to complete after initiation, and thus, earlier activation of them enabled by the enhanced proximity ranging, helps reduce or eliminate the time the user has to wait for their completion. Programmed actions are thus able to commence sooner than they otherwise would be absent the present teachings.

In FIG. 2, block 32 represents such activation profiles, which may be communicated to an IoT-capable controller 20CC as indicated by arrow 33. Such a controller 20CC may be variously embodied as a master/“smart” node in a decentralized ecosystem model 10A as shown in FIG. 3A) or a central controller 20 in a centralized ecosystem model 10B (FIG. 3B) as described below. The protocol 30 also include a proximity ranging block 34, which as represented by arrow 35 is deployed on or hosted by an initiating node 20I, e.g., the vehicle 18 of FIG. 1, the smartphone 16, etc. The proximity ranging block 34 may provide the activation rules 34R needed for operating in accordance with the disclosure.

Also included in the protocol 30 are various relay nodes 20R, including IoT capable/discoverable connected relay devices 20R within the networked ecosystem 10 operating as either lower-capability transit nodes or higher-capability smart nodes as explained below. Block 36 represents such advanced technological capabilities such as lower power limitations, higher computational capabilities, angle-of-arrival (AoA) estimation capability, or others, for the smart nodes, while block 38 represents the lower capabilities of transit nodes, e.g., RFID tags and possibly other low-power IoT devices typically in a sleep mode, thus requiring time to wake up and take actions such as proximity ranging. The protocol 30 also considers operation of the target node 20T, i.e., the intended performer of actions initiated via service activations from the initiating node 20I. The examples that will now be described with reference to FIGS. 3A-8 rely on the architecture of the basic protocol 30 of FIG. 2.

### Decentralized Model:

Referring to FIG. 3A, the decentralized ecosystem model 10A is shown in simplified form to illustrate an aspect of the present disclosure. Here, the various devices/nodes are nominally labeled A-H for simplicity. Node A represents an initiator node, for instance the smartphone 16 shown in FIG. 1, or perhaps a telematics unit of the vehicle 18. Nodes B, C, D, E, F, and G represent connected nodes, the type/number/construction of which will vary with the intended implementation. The particular device that the initiator node A intends to contact, for instance the thermostat 12 or an opener of the garage door 13 of FIG. 1, is referred to herein as a target node, with target node H serving this purpose in the non-limiting embodiment of FIG. 3A. In the decentralized ecosystem model 10A of FIG. 3A, various internodal distances separate the various nodes from one another. Nodes A and B, for example, are separated by a distance AB. Nodes A and C are similarly separated by a distance AC, and so forth. Other distances in the representative decentralized ecosystem model 10A of FIG. 3A include distances BD, CD, DE, CF, FG, GH, and FH as shown.

The decentralized multi-hop proximity ranging strategy described herein proceeds based on the following assumptions: (1) approximately 65% of the nodes are low-powered with limited communication and computational capabilities, e.g., the light bulb 17 of FIG. 1, an alarm, etc., and thus lack the capability of measuring distance, time-of-arrival (ToA), or angle-of-arrival (AoA); and (2) each node is standalone and decentralized, with peer-to-peer networks such as BLE, Zigbee, or Thread®. Nodes B, C, E, F, and G are the above-noted low-powered nodes (“transit nodes”). Node D of FIG. 3A is an ultra-wideband (UWB)-capable or Wi-Fi capable node having a higher compute capability relative to the transmit nodes, with node D possibly being embodied as the smartphone 16 or the appliance 15 of FIG. 1, or possibly a smart television (not shown) or another smart node having the capability of measuring or estimating distance, ToA, and/or AoA. Nodes B-G are collectively referred to herein as relay nodes for simplicity.

In the proposed decentralized arrangement, the extended multi-hop proximity ranging strategy enables the initiator node A to determine a distance between itself and the target node H. This is accomplished interacting with one or more of relay nodes B-G to estimate relative location and thereby determine a relative distance to the target node H. Each node based on its capability as a transit node or a smart/master node, shall be able to retry if a node is unreachable. Transit nodes may retry to the same node, exclusively, whereas the smart node D has the compute capabilities needed to intelligently select alternative routes or nodes (nodal route), and thus routes to the target node H. In other words, in response to failing to estimate the respective range to one of the neighboring nodes, i.e., as an undetected node, the present approach may include automatically reattempting to estimate the respective range to the undetected node, or automatically selecting an alternative nodal route from the initiator node 20I to the target node 20T depending on the construction of the networked ecosystem 10.

As will be appreciated by those of ordinary skill in the art, the above-described networked ecosystem 10 may be used as exemplary networked ecosystems having an initiator node 20I, a plurality of relay nodes 20R, and a target node 20T. The proximity ranging method in general includes accessing a recorded activation profile 190 in the computer storage medium 19 of FIG. 1 as a desired action or service of the target node 20T. This action may include accessing the recorded activation profile in memory of a smart node, e.g., the initiator node 20I or one of the plurality of relay nodes 20R, and may include, in one or more embodiments, accessing the recorded activation profile in memory of an ultra-wideband (UWB)-capable node or a Wi-Fi capable node, e.g., the smartphone 16 or the vehicle 18 shown in FIG. 1.

In possible implementations, this may include accessing, e.g., a light, door, appliance, and/or vehicle charging station setting of the various smart home devices illustrated in FIG. 1. The proximity ranging method ultimately includes triggering the desired action or service. This occurs in response to determining that the internodal distance between the initiator and target nodes is not greater than an activation threshold. In the centralized ecosystem model 10B of FIG. 3B discussed below, accessing the recorded activation profile may occur in memory of the central controller 20, with the central controller 20 being in remote communication, via the Wi-Fi router 22, with: (a) the initiator node 20I and one or more of the relay nodes 20R, and (b) one or more of the relay nodes 20R and the target node 20T via the Wi-Fi router 22 and the border router 24.

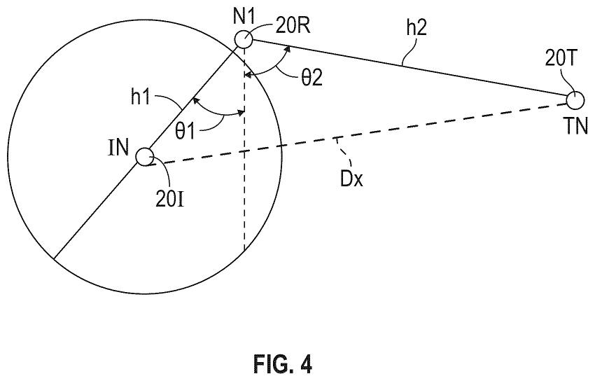

Embodiments of the method include detecting, via the initiator node 20I using the proximity ranging protocol 30 of FIG. 2, respective ranges to one or more neighboring nodes of the plurality of relay nodes 20R within a range limit of the initiator node 20I, with the target node 20T located outside of the range limit of the initiator node 20I as shown in FIGS. 3A and 3B. The disclosed proximity ranging method may also include dynamically determining an internodal distance D_{X} (FIG. 4) between the initiator node 20I and the target node 20T using the respective ranges to the one or more neighboring nodes.

### Centralized Model:

Referring now to FIG. 3B, the centralized ecosystem model 10B illustrates another aspect of the present disclosure. As with the decentralized ecosystem model 10A of FIG. 3A, the various devices/nodes are nominally labeled A-H for simplicity. Node A represents the initiator node. Nodes B, C, D, E, F, and G represent relay nodes, most or all of which may be configured as the above-described transmit nodes and none, one, or more of which may be configured as more computationally capable smart nodes. The centralized ecosystem model 10B of FIG. 3B differs from the decentralized ecosystem model 10A of FIG. 3A in the inclusion of additional network nodes, in this case a central controller 20, a Wi-Fi router 22, and a border router 24, e.g., a Thread® border router.

As appreciated in the art, the border router 24 may be used to connect a local network to the internet via the Wi-Fi router 22, or to a wider network or networks. As its name implies, the border router 24 may be located at an edge of a network, in this case one served by the Wi-Fi router 22. Functionally, the border router 24 is used to route data traffic and thus act as a gateway between a local network and one or more external networks. The Wi-Fi router 22 for its part is used to communicate with nodes within a given local network, e.g., nodes A, B, C, and D in the non-limiting simplified embodiment of FIG. 3B, as represented by lines 220. The Wi-Fi router 22 may also be connected to the internet e.g., via an ethernet box the Wi-Fi router 22 is connected to, connection to a fiber or coax cable, a cellular link, or others. The border router 24 connects other nodes, e.g., nodes E, F, G, and H, to the Wi-Fi router 22 as indicated by line 26. The Wi-Fi router communicates with the optional central controller 20 as indicated by line 25, with lines 25, 26, 220, and 240 representing wireless communication pathways within the networked ecosystem 10.

The centralized version of the present multi-hop strategy proceeds with the following assumptions: (1) some of the nodes are ultra-wideband (UWB)-capable nodes, e.g., the smartphone 16 or other mobile device, or the vehicle 18 of FIG. 1, a moving robot (not shown), etc., (2) each UWB-capable node has the capability to measure ToA or AoA, e.g., using multiple antennas, such that one or more UWB-capable nodes are able to determine the relative location of other UWB nodes, and (3) each UWB-capable node is connected to the central controller 20 through wireless networks as shown. As appreciated in the art, UWB-capable sensors are configured to use a designated large portion of the radio spectrum, typically 3.1 GHz to 10.6 GHz, for the purpose of high-speed data transmission over relatively short distances.

Among other attendant benefits, low-power UWB-capable sensors when used in the context of the centralized ecosystem model 10B of FIG. 3B enable accurate localization and real-time tracking of objects of interest. As the above-noted frequency range is widely spread, UWB sensors are less susceptible to interference from Wi-Fi or Bluetooth™ devices, making UWB sensors optimal for IoT applications of the type contemplated herein. Thus, detecting the respective ranges to the one or more neighboring nodes within the scope of the disclosure may include using one or more UWB-capable nodes to measure a time-of-arrival (ToA) and an angle-of-arrival (AoA) of a signal from the one or more neighboring nodes.

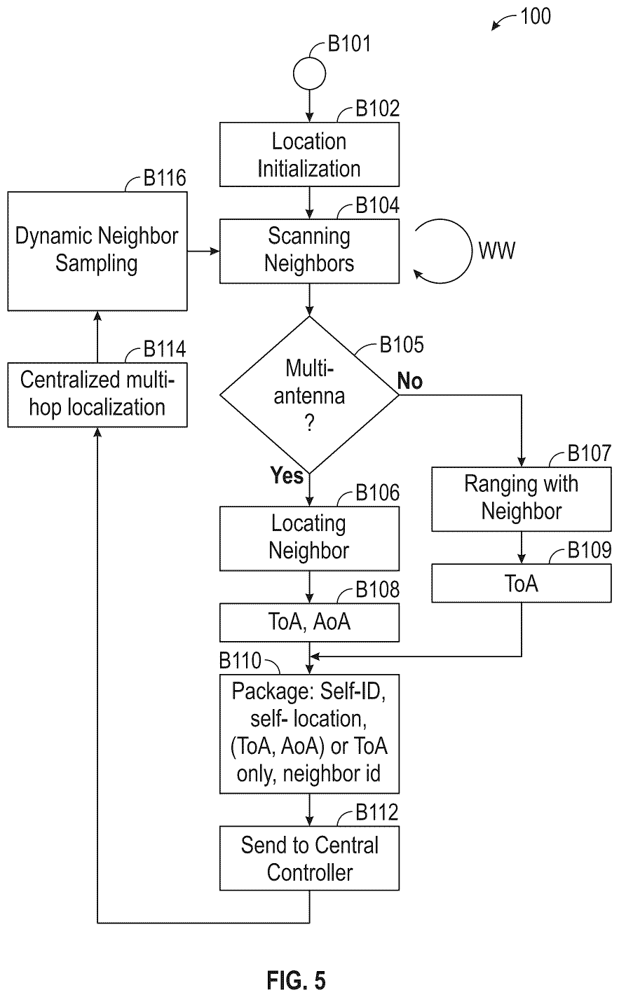

Features of the centralized multi-hop strategy include local distance map creation, centralized multi-hop localization, and dynamic neighbor sampling. For local distance map creation, each UWB-capable node periodically scans neighboring nodes, the periodicity of the scan being determined by the mobility of the network or a determination of the capabilities of the neighboring nodes. An approach for implementing centralized multi-hop localization is described below with reference to FIG. 5. Regarding dynamic neighbor sampling, a shortest distance or path algorithm may be used to find the path, with scanning periodicity increased on ranging path nodes. Thus, the proximity ranging method described herein may include using a shortest distance algorithm to determine a nodal path from the initiator node 20I to the target node 20T through the one or more neighboring nodes.

Referring to FIG. 4, the various nodes may serve as a relay node (N1) 20R when the initiator node (IN) 20I attempts to contact the target node (TN) 20T. In the simplified illustration, the initiator node 20I is separated from a relay node (N1) 20R by a distance h1, and the target node 20T is out-of-range of the initiating node 20I. The relay node 20R is separated from the target node (TN) 20T by a distance h2. The true distance between the initiating node 20I and the target node 20T, however, cannot be solely obtained using h1 and h2.

Estimating the distance between the initiator node 20I and the target node 20T is possible if one of the two following sets of requirements hold true: (1) there is one relay node 20R in range of both the initiating node 20I and the target node 20T, as depicted in FIG. 3A, and the relay node 20R is a smart/master node capable of identifying both the distance h1 (e.g., based on ToA) and the AoA (θ1) between itself and the initiating node 20I, as well as the distance h2 and AoA (θ2) between itself and the target node 20T; or (2) there are three or more relays nodes N1, N2, and N3, the latter two of which are not shown, in range of both the initiating node 20I and the target node 20T, with none of the nodes 20I, 20T, or the relay nodes 20R being smart nodes (i.e., capable solely of ranging), and with the initiating node 20I knowing the location of each of the relay nodes (N1, N2, N3). When set (1) of the above-stated requirements holds, it is possible to calculate the distance Dx between nodes 20I and 20T (i.e., via D_{X}=\sqrt{h₁²+h₂²−2h₁h₂ cos(θ₁+θ₂)}). When set (2) of the requirements holds, it is possible to ascertain the range between the initiating node 20I and the target node 20T using trilateration, i.e., similar to operation of the global positioning system (GPS) constellation of satellites.

Some embodiments may include dynamically determining an internodal distance between the initiator node 20I and target node 20T by recursively determining an internodal distance between first and second nodes, e.g., the initiator node 20I and/or a pair of relay nodes 20R, using an intermediate node. The first, second, and intermediate nodes are one of the aforementioned initiator, relay, and target nodes. The second node in this illustrative example is outside the range limit of the first node, and the intermediate node is in range limit of both the first and second nodes. The first node, the second node, and the intermediate node are nodes on a determined ranging route between the initiator node and the target node.

Referring now to FIG. 5, local distance map creation as noted above may be implemented using an algorithm or method 100. For clarity, each process step of the method 100 is described as a separate set of code and organized as logic blocks. Depending on the action, the various blocks may be performed by a particular node of the decentralized ecosystem model 10A (FIG. 3A) or the centralized ecosystem model 10B (FIG. 3B), either of which may be used to construct and control the exemplary IoT ecosystem 10 of FIG. 1.

Upon starting the method 100 at block B101, and referring to the exemplary embodiments of FIGS. 3A and 3B, the method 100 proceeds to block B102 (“Location Initialization”), whereupon the initiator node 20I initializes location of the out-of-range target node 20T. The method 100 then proceeds to block B104.

Block B104 (“Scanning Neighbors”) entails communicating via the initiator node 20I with neighboring nodes within its communication range. As some of the neighboring nodes may be in a sleep or low-power mode, such nodes will be triggered to wake up at block B104, as indicated by arrow WW. The method 100 thereafter proceeds to block B105.

At block B105 (“Smart Node?”) of FIG. 5, the method 100 includes determining whether the neighboring node that was scanned at block B104 is a master/smart node as described above. Block B104 therefore entails ascertaining the compute functionality of the neighboring nodes in terms of one or more neighboring nodes being a lower capability transit node or a higher capability smart node, i.e., one having multiple antennas and capable of determining time-of-arrival (ToA) and/or angle-of-arrival (AoA). The method 100 proceeds to block B106 when the neighboring node is a smart node, and to block B107 when the neighboring node is a transit node.

Block B106 (“Locating Neighbor”) involves initializing locating a neighboring node having smart capabilities. The method 100 thereafter proceeds to block B108.

Block B107 (“Ranging w/Neighbor”) involves locating a neighboring node that lacks the requisite multi-antenna structure needed for enabling smart capabilities. The method 100 thereafter proceeds to block B109.

Block B108 (“ToA, AofA”) of FIG. 5 includes determining the time-of-arrival (ToA) and the angle-of-arrival (AoA) of the neighboring node located at block B106. Time-of-arrival as appreciated in the art involves a receiver node measuring the time at which a transmitted signal is received from a neighboring node. Once time-of-arrival has been measured, the internodal distance (D) is easily calculated as the product of ToA and signal speed, i.e., light speed. Angle-of-arrival (AoA) as the name implied determines the direction from which a signal arrives at a receiving node, with an antenna array detecting the signal with a slight phase and amplitude difference. AoA is then determined based on the measured phase and amplitude differences, e.g., using beamforming or other suitable algorithms. The method 100 proceeds to block B110 once the ToA and/or AoA have been determined.

At block B109 (“ToA”), the initiator node determines the time-of-arrival (ToA) of the neighboring node located at block B106. As the receiver node is a transit node in this instance, time-of-arrival is the only information available to the receiver node. The method 100 proceeds to block B110 once the ToA has been determined.

At block B110 (“Package”), the initiator node 20I generates a data package of relevant information for communication to the neighboring node. The data package may include, e.g., the unique identifier of the initiator node, ToA and/or AoA information from blocks B108 or B109 as described above, a unique identifier of the neighboring node (e.g., an alphanumeric string or bit code, etc.). The method 100 thereafter proceeds to block B112.

At block B112 (“Send Package”) of FIG. 5, the initiator node 20I transmits the package from block B110 to the central controller 20 when using the representative embodiment of FIG. 3A described above. Embodiments of the proximity ranging method in general therefore include transmitting the data package to the one or more neighboring nodes, with the data package including a unique identifier and location of the initiator node 20I, the ToA and the AoA, and a unique identifier of the one or more neighboring nodes. In response to the data package being received from the initiator node 20I, block B112 or another block may include sending a response data package via each of the one or more neighboring nodes, including sending the unique identifier of each of the one or more neighboring nodes, the angle-of-arrival of reception of the data package, and the time-of-arrival of the data package. The method 100 thereafter proceeds to block B114.

Still referring to FIG. 5, the method 100 next includes performing a centralized multi-hop localization algorithm using the information in the packet from block B112, e.g., via the controller 20 of FIG. 3B. A representative set of code usable for this purpose is as follows:

```
Begin:
Initialize graph G with received node packages
For each node i in G
    if node i has no location data or is mobile
      find neighbor nodes θ whose self-locations are available
      if # of master node > 1 or # of transit node > 3
        calculate node I location based on neighbor's location, ToA and
        AoA
        update node i location
        add node i, node in θ and their edge in graph G′
mindist, path = Findshortestdistance (initiator, target, graph G′)
if mindist > 0 or try > maximal tries
  return path
else
  try ++
  goto: Begin
```

The method 100 thereafter proceeds to block B116.

At block B116 (“Dynamic Neighbor Sampling”), the initiator node 20I receives the path from block B114 and performs a dynamic neighbor sampling routine. As appreciated in the art, such a technique may be used to monitor and manage the status of various neighboring nodes. In general, each node maintains a local list or table of its neighboring nodes, i.e., those within a distance limit for communication, which in turn may be several dozen meters or less depending on the embodiment. Using dynamic neighbor sampling, the initiator node 20I or other sampling node performs the step of periodically checking the status and connectivity of the neighboring nodes at a sampling frequency, with the sampling frequency dynamically adjusted upward or downward as needed based on a characteristic of the one or more neighboring nodes, for example node behavior/the presence of changes or abnormalities, neighboring node movement, speed of movement, rate of a selected neighboring node going out of proximity range limit, etc. Higher sampling frequencies may be used when the node is mobile or on the path determined at block B114. The method 100 then proceeds to block B104.

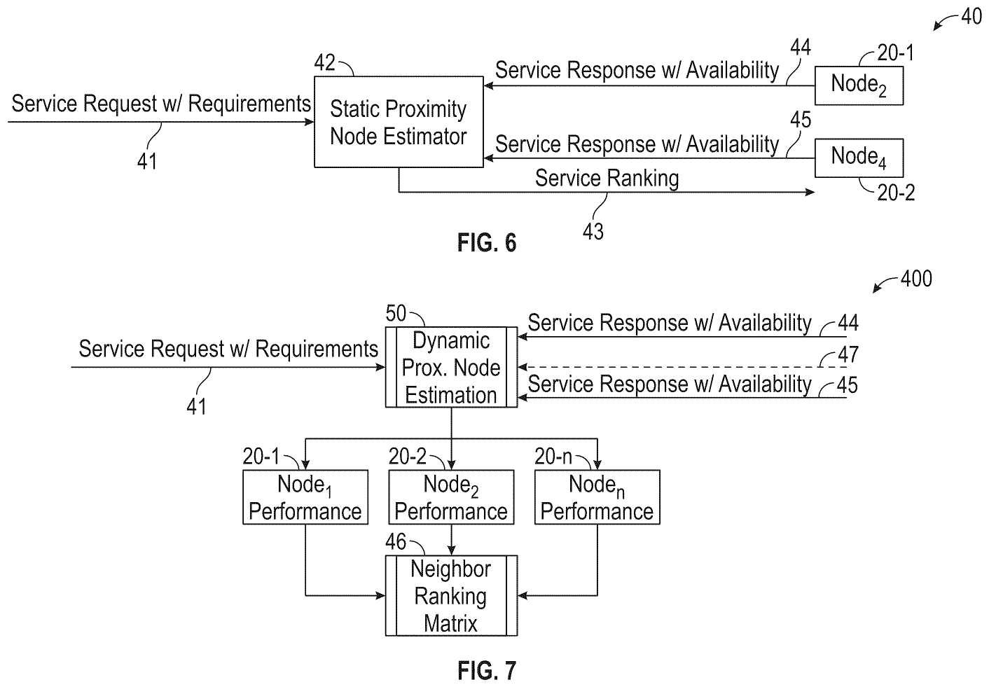

Referring to FIGS. 6 and 7, dense environment models may be used for estimating proximity and for dynamically ranking neighboring nodes. FIG. 6 for example illustrates a model 40 of information flow for a decentralized approach as described above. In general, service requests and requirements (arrow 41) are transmitted or otherwise communicated to a static proximity node estimator block 42, e.g., a logic block hosted at a static node. Connected relay nodes 20-1 and 20-2 respectively communicate a service response and node availability status (arrows 44 and 45) to the static proximity node estimator block 42 in response to a service ranking (arrow 43) therefrom. The service ranking (arrow 43) may be generated from the maintained local list or table of neighboring nodes noted above.

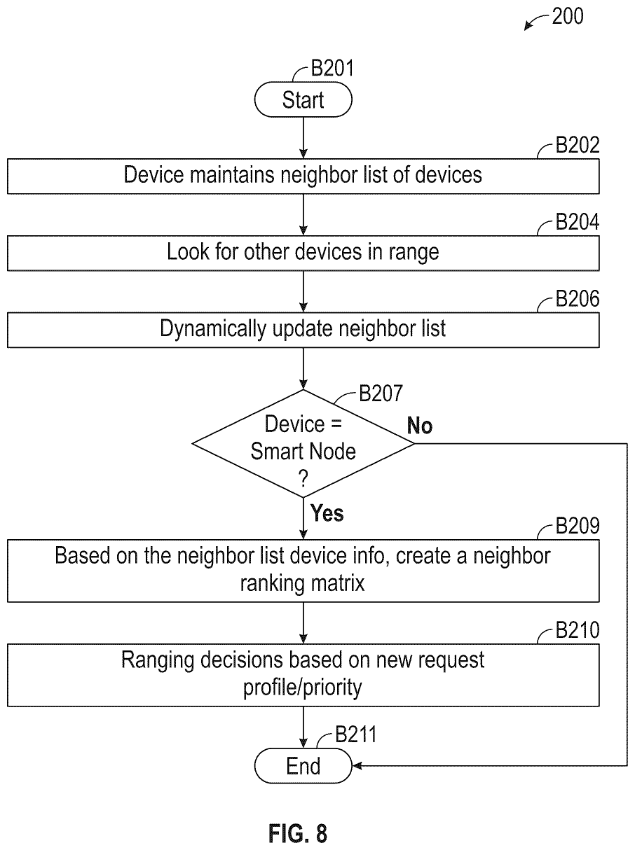

FIG. 7 for its part generally describes a model 400 for implementing dynamic neighbor ranking. As with FIG. 6, the model 400 of FIG. 7 commences with the service requests and requirements (arrow 41). Here, however, the service requests and requirements (arrow 41) are received by a dynamic proximity node estimation block 50, with an exemplary method 200 for implementing the functions of block 50 being described below with reference to FIG. 8. The above-described service response and node availability status (arrows 44, 45, 47) are directed to block 50, which thereafter communicates with nodes 20-1, 20-2, . . . , 20-n to evaluate their respective performance capabilities. The broken line of arrow 47 is indicative of the possibility of more than two nodes.

Model 400 additionally entails rank-ordering one or more neighboring nodes, in this case the various nodes 20-1, 20-2, . . . , 20-n, in a matrix or table 46 for use in the present IoT ecosystem 10. In scenarios in which the initiator node has multiple nodes as proximity ranging options, then block 50 of FIG. 7 will maintain and dynamically update the table 46 to prioritize neighboring nodes for the action or service, doing so based on predetermined criteria. For example, prioritization may consider criteria such as performance, energy efficiency, etc. The nodes are then ranked for each application/service request.

Referring to FIG. 8, a flow diagram illustrating method 200 may be used for implementing model 400. After starting at a start block B201, block B202 is performed for each node, e.g., each IoT device in the exemplary IoT ecosystem 10 of FIG. 1. At block B202, the node(s) maintain a list of neighboring nodes within the communication range of the node. The list is thus local, i.e., specific to the specific node maintaining the list.

At block B204, the node looks for other in-range nodes each time the node moves. For example, if a user of the IoT ecosystem 10 of FIG. 1 carries the smartphone 16 as the user walks through their home 11, the smartphone 16 scans for other in-range devices in the home 11.

Block B206 of FIG. 8 entails dynamically updating the above-noted neighbor list for the node's latest location. Scanning frequency may be adjusted in real time as described above, either upward or downward depending on network stability and the nature of the nodes coming into or out of range.

At block B207, the scanning node performing blocks B202, B204, and B206 next determines if it is a higher-capability master/smart node as described above. If so, the flow diagram proceeds to block B209, with the flow ending if the initiator/scanning node is a transit node.

Block B209, arrived at when the scanning node is a smart node, includes creating the neighbor ranking table or matrix for applications, an approach for which is described above with reference to FIG. 7. This action is performed based on the information in the neighbor list/table/matrix from block B206.

At block B210, the scanning node next makes proximity ranging decisions based on a new request profile or priority, doing so using the neighbor ranking matrix from block B209. The method 200 thereafter proceeds to terminal block B211, i.e., end.

The above teachings as illustrated in FIGS. 1-8 provide a multitude of potential benefits when applied to an IoT context. For example, the solutions enable extended multi-hop proximity ranging to enhance multi-service activation across various connected devices in the smart home 11 of FIG. 1 before the user leaves for work. Each device may perform sequential service activation of another out-of-range device based on user-selected profiles such as “go to work”, “evening”, etc. In a possible use scenario, the user may initiate a morning routine to go to work starting from a bedroom of the smart home 11 to the vehicle 18. Today, one might set a “morning” profile to activate available services sequentially. Often, the next routine may be triggered early or late based on efficiency of the user's previous activity within the profile.

Multi-hop proximity ranging service activation in accordance with the present disclosure enhances sequential service activation based on a profile. By allowing a service within a set of sequential services within a profile to be triggered ahead of the user device, e.g., the smartphone 16 of FIG. 1, falling within the maximum single-hop proximity range to leverage that particular service. For instance, a person holding a smart device such as the smartphone 16 or a smart watch, approaching a garage in the smart home 11 of FIG. 1 may, by their proximity, trigger activation of the light bulb 17. The light bulb 17 may then simultaneously range to and activate the various other devices, which are otherwise out-of-range relative to the user/initiator node (e.g., the smartphone 16, smart watch, etc.) based on the original stored profile and capabilities of the various nodes. Faster triggering of services is thus enabled by the present teachings, thus addressing the above-noted latency issues that may render existing IoT applications less than optimal. These and other attendant benefits will be readily appreciated by those possessing ordinary skill in the art in view of the foregoing disclosure.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A proximity ranging method for use in a networked ecosystem, the networked ecosystem having an initiator node, a plurality of relay nodes, and a target node, the ranging method comprising:
accessing a recorded activation profile in a computer storage medium as a desired action or service of the target node;
estimating, via the initiator node using a proximity ranging protocol, respective proximity ranges to one or more neighboring nodes of the plurality of relay nodes within a range limit of the initiator node, wherein the target node is located outside of the range limit of the initiator node;
dynamically determining an internodal distance between the initiator node and the target node based at least in part on the respective ranges to the one or more neighboring nodes; and
triggering the desired action or service upon determining that the internodal distance between the initiator and the target node is not greater than an activation threshold.

2. The method of claim 1, wherein the one or more neighboring nodes are within a range limit of the target node.

3. The method of claim 1, wherein determining the internodal distance between the initiator node and the target node is further based on estimating an angle-of-arrival of a signal exchanged between the initiator node and a neighboring node, and estimating an angle-of-arrival of a signal exchanged between the target node and the neighboring node.

4. The method of claim 1, wherein estimating the respective range to a neighboring node is further based on a time-of-arrival of a signal sent by the initiator node to the neighboring node.

5. The method of claim 1, further including upon estimating the range to a neighboring node, instructing the neighboring node to estimate the range between itself and the target node, wherein the instructing includes sending a signal to the neighboring node.

6. The method of claim 1, wherein the dynamically determining an internodal distance between the initiator node and the target node further includes recursively determining an internodal distance between a first node and a second node using an intermediate node, wherein the second node is outside the range limit of the first node, wherein the intermediate node is in range limit of both the first node and the second node, and wherein the first node, the second node, and the intermediate node are nodes on a determined ranging route between the initiator node and the target node.

7. The method of claim 1, further comprising:
in response to failing to estimate the respective range to one of the neighboring nodes, as an undetected node, reattempting to estimate the respective range to the undetected node, or selecting an alternative nodal route from the initiator node to the target node.

8. The method of claim 1, wherein accessing the recorded activation profile in the computer storage medium includes:
accessing the recorded activation profile in memory of a central controller, the central controller being in remote communication, via a Wi-Fi router, with: (a) the initiator node and one or more of the relay nodes, and (b) one or more of the relay nodes and the target node via the Wi-Fi router and a border router.

9. The method of claim 1, wherein estimating the respective ranges to the one or more neighboring nodes includes measuring a time-of-arrival (ToA) and an angle-of-arrival (AoA) of a signal sent by the initiator node to the one or more neighboring nodes.

10. The method of claim 9, wherein the measuring the time-of-arrival (ToA) and the angle-of-arrival (AoA) of a signal is performed using an ultra-wideband (UWB)-capable node.

11. The method of claim 9, further comprising:
using a shortest distance algorithm to determine a nodal path from the initiator node to the target node through the one or more neighboring nodes.

12. The method of claim 9, further comprising:
generating a data package via the initiator node; and
transmitting the data package to the one or more neighboring nodes, the data package including a unique identifier of the initiator node, the ToA and the AoA, and a unique identifier of the one or more neighboring nodes.

13. The method of claim 12, further comprising:
in response to the data package being received from the initiator node, sending a response data package via each of the one or more neighboring nodes, including sending the unique identifier of each of the one or more neighboring nodes, an angle-of-arrival of reception of the data package, and the time-of-arrival of the data package.

14. The method of claim 1, further comprising:
periodically checking a status and connectivity of the one or more neighboring nodes at a sampling frequency; and
adjusting the sampling frequency based on a characteristic of the one or more neighboring nodes.

15. The method of claim 1, further comprising:
rank-ordering the one or more neighboring nodes in a table based on predetermined criteria; and
dynamically updating the table to thereby prioritize the one or more neighboring nodes for the action or service.

16. The method of claim 1, wherein:
the initiator node includes a smartphone or a vehicle and the target node includes a smart home device; and
accessing the recorded activation profile includes accessing a recorded light, door, appliance, and/or vehicle charging station setting of the smart home device.

17. A networked ecosystem comprising:
an initiator node;
a plurality of relay nodes, including at least one transit node and at least one smart node;
a target node that is located outside of a range limit of the initiator node; and
computer storage medium (memory) containing a recorded activation profile, the recorded activation profile including a desired action or service of the target node;
wherein the networked ecosystem is configured to use a proximity ranging protocol to detect respective ranges to one or more neighboring nodes of the plurality of relay nodes within a range limit of the initiator node, to dynamically determine an internodal distance between the initiator node and the target node based at least in part on the respective ranges to the one or more neighboring nodes, and triggering the desired action upon determining that the internodal distance between the initiator and the target node is not greater than an activation threshold.

18. The networked ecosystem claim 17, wherein the computer storage medium is part of the initiator node or the least one smart node, and wherein the initiator node or the least one smart node is configured as an ultra-wideband (UWB) node or a Wi-Fi capable node.

19. The networked ecosystem claim 17, further comprising:
a Wi-Fi router;
a border router; and
a central controller in communication with the initiator node and one or more of the relay nodes via the Wi-Fi router, and with the one or more of the relay nodes and the target node via the Wi-Fi router and the border router.

20. A networked ecosystem comprising:
an initiator node, the initiator node including a smartphone or a vehicle and having an ultra-wideband (UWB) capability;
a plurality of relay nodes, including at least one transit node and at least one smart node, the at least one smart node including the UWB capability;
a target node that is located outside of a range limit of the initiator node, the target node being configured as a smart home device;
a computer storage medium (memory) containing an activation profile, the activation profile including a desired action or service of the target node, the desired action or service including a light, door, appliance, and/or vehicle setting of the smart home device;
a Wi-Fi router;
a border router; and
a central controller in communication with the initiator node and one or more of the relay nodes via the Wi-Fi router, and with the one or more of the relay nodes and the target node via the Wi-Fi router and the border router, wherein the networked ecosystem is configured to use a proximity ranging protocol to detect respective ranges to one or more neighboring nodes of the plurality of relay nodes within a range limit of the initiator node, dynamically determine an internodal distance between the initiator node and the target node using the respective ranges to the one or more neighboring nodes, rank-order the one or more neighboring nodes in a table based on predetermined criteria, and dynamically update the table to thereby prioritize the one or more neighboring nodes for the action or service.
